(19) United States
(12) Patent Application Publication
(10) Pub. No.: US 2021/0195354 A1
(43) Pub. Date: Jun. 24, 2021

(54) MICROPHONE SETTING ADJUSTMENT

(71) Applicant: Lenovo (Singapore) Pte. Ltd., Singapore (SG)

(72) Inventors: Adam Jerome Cavenaugh, Cary, NC (US); Kenneth Scott Seethaler, Raleigh, NC (US); David W. Douglas, Cary, NC (US)

(21) Appl. No.: 16/724,674

(22) Filed: Dec. 23, 2019

(51) Int. Cl. H04R 29/00; G10L 25/51; G06F 3/01; H04R 3/00

(52) U.S. Cl. CPC H04R 29/004; H04R 3/00; G06F 3/013; G10L 25/51

(57) ABSTRACT

One embodiment provides a method, including: capturing, using at least one sensor associated with an information handling device, environmental data in a user's location; determining, from the environmental data, an optimal microphone mode for audible input capture in the user's location; and adjusting, based on the determining, at least one microphone setting to activate the optimal microphone mode. Other aspects are described and claimed.

### BACKGROUND

Users are capable of interacting with their information handling devices (“devices”), for example laptop and/or personal computers, tablet devices, smart phones, smart speakers, and the like, through a variety of different input means. For example, one popular way of interacting with a device is through voice input. More particularly, a user's device may contain one or more audio capture devices (e.g., microphones, etc.) that are capable of capturing user-provided audio. Once the audio is captured, it may thereafter be processed and utilized in a downstream process.

### BRIEF SUMMARY

In summary, one aspect provides a method, comprising: capturing, using at least one sensor associated with an information handling device, environmental data in a user's location; determining, from the environmental data, an optimal microphone mode for audible input capture in the user's location; and adjusting, based on the determining, at least one microphone setting to activate the optimal microphone mode.

Another aspect provides an information handling device, comprising: at least one sensor; a processor; a memory device that stores instructions executable by the processor to: capture environmental data in a user's location; determine, from the environmental data, an optimal microphone mode for audible input capture in the user's location; and adjust, based on the determining, at least one microphone setting to activate the optimal microphone mode.

A further aspect provides a product, comprising: a storage device that stores code, the code being executable by a processor and comprising: code that captures environmental data in a user's location; code that determines, from the environmental data, an optimal microphone mode for audible input capture in the user's location; and code that adjusts, based on the determining, at least one microphone setting to activate the optimal microphone mode.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of dynamically adjusting a microphone setting based upon environmental data in a user's location.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users audibly interact with their devices in a variety of different locations. Each of these locations likely has a particular audio input context that is different than the other locations. More particularly, depending upon the ambient noise in the user's location, the quality of audio captured by microphones associated with the user's device may be affected. For example, a user interacting with their device in a loud environment (e.g., a restaurant, a noisy room, etc.) may find that extraneous noise was captured along with their intended user inputs.

Existing solutions enable users to manually adjust the microphone settings to narrow or expand the microphone pickup beam. For example, users situated in a loud environment may desire a narrower beam so that the ambient noise may be excluded, thereby allowing only their voice input to be registered. Alternatively, as another example, users engaged in a conference call may desire a wider beam to allow for all of the voice inputs provided by the conference attendees in the room to be adequately detected.

Currently, however, facilitation of these adjustments may only be accomplished through navigation through a variety of different settings menus. For users that know that the foregoing beamforming adjustments are possible, such a requirement may be burdensome and time-consuming, especially if they do not know exactly where these settings are located. Alternatively, for users that do not know that the foregoing beamforming adjustments are possible, they may continue to operate in a sub-optimal manner, which may affect the quality of their audio inputs.

Accordingly, an embodiment provides a method for adjusting a microphone setting to better accommodate the contextual audible input situation. In an embodiment, environmental data in a user's location may be captured by at least one sensor of a device. The environmental data may include ambient audio data, gaze direction data, occupancy data, individual position data, and the like. An embodiment may then determine, from the environmental data, an optimal microphone mode for capturing audio input while in the user's location. Achievement of the optimal microphone mode may be accomplished by narrowing or widening the pickup area of the microphone(s). Thereafter, an embodiment may automatically adjust, without additional user input, a microphone setting on the device to achieve the optimal microphone mode. Such a method may negate the conventional need for users to navigate through confusing microphone settings to improve the quality of audio input in varying situations.

The illustrated example embodiments will be best understood by reference to the figures. The following description is intended only by way of example, and simply illustrates certain example embodiments.

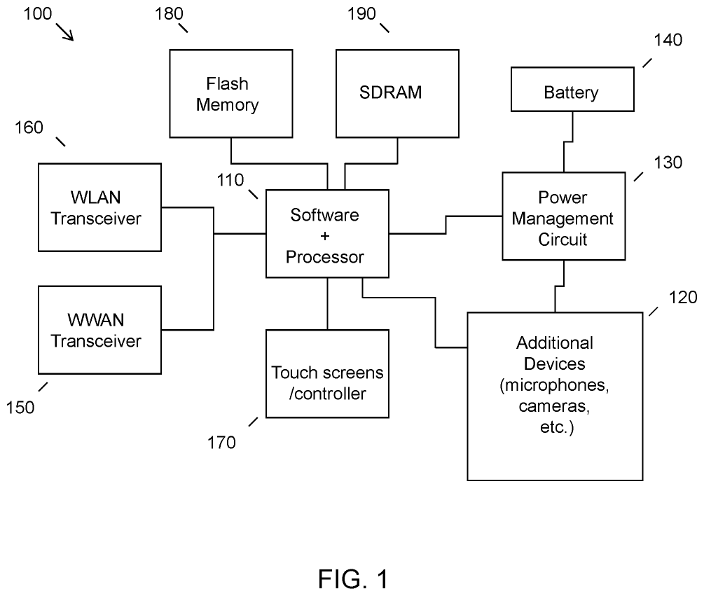

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

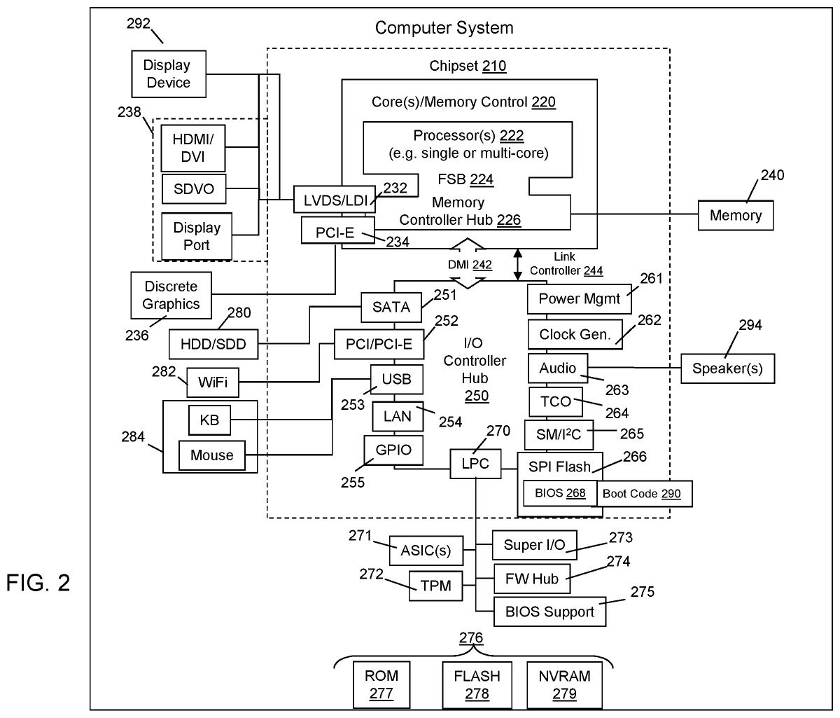

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices capable of capturing and processing audible inputs. For example, the circuitry outlined in FIG. 1 may be implemented in a smart phone or tablet embodiment, whereas the circuitry outlined in FIG. 2 may be implemented in a laptop.

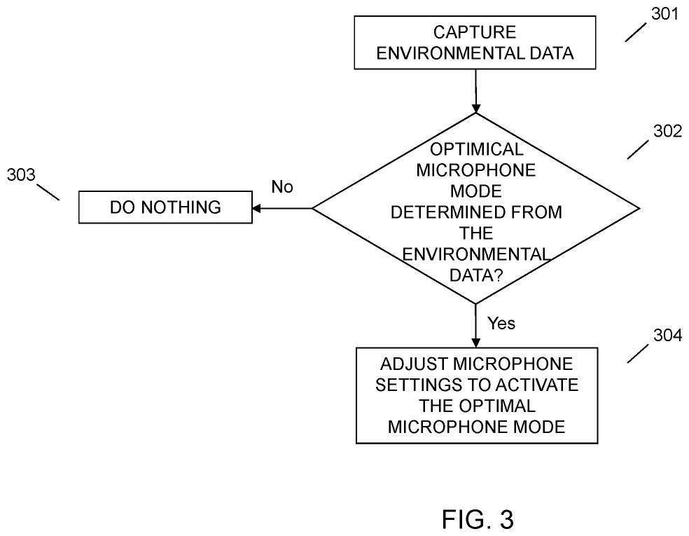

Referring now to FIG. 3, an embodiment provides a method for dynamically adjusting a microphone setting based upon a user's contextual audio input situation. At 301, an embodiment may utilize at least one sensor associated with the device to capture environmental data in a user's location. In an embodiment, the sensor(s) may be integrated into the device, or, alternatively, may be integrated into another device but may be capable of transmitting sensor data to the device (e.g., via a wired or wireless connection, etc.). In an embodiment, the sensor(s) may always be on and continuously capture data or, alternatively, may only begin data capture responsive to a predetermined event (e.g., responsive to receiving an explicit user command to capture data, etc.).

In an embodiment, environmental data may correspond to one or more different data types. For example, the environmental data may correspond to image or video data captured by a camera sensor (e.g., an image or video of the number of individuals in a space, the direction the individuals are facing, etc.). As another example, the environmental data may correspond to audio data captured by a microphone or microphone array (e.g., the volume of ambient noise in a space, the determined direction from which audio was provided, etc.). In yet another embodiment, the environmental data may correspond to distance data obtained from a Time-of-Flight (ToF) sensor (e.g., distance data from an individual in the room to the device, etc.). In the context of this application, ToF sensors may refer to virtually any device or process, used alone or in combination, capable of distance detection such as radar, Light Detection and Ranging (“Lidar”), laser, ultrasound, and the like. In yet another embodiment, Global Positioning System (GPS) data may be utilized to determine the nature or identity of the user's location (e.g., an embodiment may determine that the user is at home, work, a particular restaurant, monument, building, etc.).

At 302, an embodiment may determine, from the captured environmental data, an optimal microphone mode for audio input capture in the user's location. In the context of this application, the optimal microphone mode may correspond to a mode in which the quality of the captured audio input is above a predetermined threshold quality standard for the user's contextual situation (e.g., the best microphone mode when: the user alone is providing input to a device, when a plurality of users are providing input to a device, when the user is in a loud or quiet environment, when the user is in a particular location, etc.). The subsequent determination techniques may be used alone or in combination to determine the optimal microphone mode.

In an embodiment, the determination of the optimal microphone mode may be facilitated by identifying that the user's location is associated with a high noise location. From this identification, an embodiment may conclude that the optimal microphone mode corresponds to a user only mode. In the context of this application, the user only mode may correspond to a mode where substantially only a single user's inputs are captured by the device. More particularly, the microphone(s) of the device in the user only mode may be configured to have a narrow audio pickup beam that may capture audio a limited range in front of the microphone and ignore all other ambient sound.

In an embodiment, the identification that the user's location is associated with a high noise location may be accomplished, for example, by simply using the microphone(s) to determine whether the volume of captured audio in the user's location is above a predetermined volume threshold. Additionally or alternatively, other sensors may also be utilized to further confirm that that the user's location is associated with a high noise location. For example, one or more camera sensors may be utilized to capture one or more images of other individuals in the user's location and predict, responsive to identifying that there are more than a threshold number of individuals in the image (e.g., 10, 15, etc.), that the user's location is associated with a high noise location (i.e., from the implication that more individuals in a space creates more noise). In yet another embodiment, a GPS sensor unit may receive location data for the user's location and an embodiment may predict, from the location data, that the user's location is associated with the high noise location. For example, an embodiment may identify that the user is located at a sports stadium and may conclude from this identification that the user is likely in a high noise environment.

In an embodiment, the determination of the optimal microphone mode may be facilitated by identifying that the user's location is associated with a conference setting. From this identification, an embodiment may conclude that the optimal microphone mode corresponds to a multiple voices mode. In the context of this application, the multiple voices mode may correspond to a mode where audio inputs provided by a multitude of different users, potentially located in disparate positions around the user's location, can be appropriately captured by the device. More particularly, the microphone(s) of the device in the multiple voices mode may be configured to have a wider audio pickup beam that may capture audio from more positions in the user's location.

In an embodiment, the identification that the user's location is associated with a conference setting may be accomplished by identifying that a predetermined number of individuals are present in the user's location. For example, one or more camera sensors may first be utilized to capture one or more images of the individuals in the user's location. An embodiment may then determine whether a predetermined number of individuals are present in the image, wherein the predetermined number provides an implication to the system that a conference is on-going. Additionally or alternatively, an embodiment may utilize one or more image analysis techniques known in the art to determine the identities of the individuals in the captured image. These identities may be compared with available context data (e.g., calendar data, communication data, social media data, etc.) to determine that one or more identified individuals in the images were scheduled to participate in a conference meeting. Additionally or alternatively, an embodiment may utilize one or more microphones to determine whether a predetermined number of audio streams are directed at the device. More particularly, an embodiment may leverage one or more localization techniques to determine the direction from which the captured audio is provided from. In the same vein, one or more ToF sensors may be utilized alone, or in combination with, the audio localization techniques to determine the distance from which the audio-providing individuals are located from the device, whereby a closer distance may indicate an explicit intention to interact with the device (e.g., as part of a conference, etc.). In another embodiment, gaze detection techniques may also be utilized alone, or in combination with the foregoing, to determine whether a predetermined number of user gazes (e.g., 3, 5, 10, etc.) are directed at the device, or a particular portion of the device. In an embodiment, the number of detected gazes associated with the predetermined number may be reflective of a conference setting.

In an embodiment, the determination of the optimal microphone mode may be facilitated by identifying that the user's location is associated with a standard setting. From this identification, an embodiment may conclude that the optimal microphone mode corresponds to a normal mode. In the context of this application, the normal mode may correspond to a mode where the microphones are configured to capture audio in a medium-range beam. More particularly, a device in the normal mode may adequately capture voice input provided by users located proximate to the microphone (e.g., in a standard location directly in front of the display screen of the device, etc.) as well as voice input originating a moderate distance away from the microphone. In an embodiment, the normal mode may be the default mode for the device that is reverted to each time the device is reset, each time the device is powered on, each time the user logs into their profile, etc.

Responsive to not determining, at 302, an optimal microphone mode, an embodiment may, at 303, take no additional action. Additionally or alternatively, an embodiment may maintain and capture audio input using an existing microphone mode. Conversely, responsive to determining, at 303, the optimal microphone mode, an embodiment may, at 304, adjust one or more microphone settings to institute the determined optimal microphone mode.

In an embodiment, institution of the optimal microphone mode may be conducted dynamically, without additional user input, by the system. More particularly, an embodiment may have access to knowledge (e.g., stored in an accessible database, etc.) regarding which settings need to be adjusted to accommodate each microphone mode. Responsive to determining a particular optimal microphone mode, the system of the embodiments may dynamically activate or adjust the microphone settings to achieve that mode.

The various embodiments described herein thus represent a technical improvement to conventional methods of dynamically adjusting the microphone settings on a user's device to accommodate the user's contextual input situation. Using the techniques described herein, an embodiment may capture environmental data associated with the user's location. An embodiment may then determine, from the environmental data, a microphone mode that is optimized for audio capture in the user's location and thereafter adjust one or more microphone settings to achieve the optimal microphone mode. Such a method may negate the conventional need for a user to constantly adjust their microphone settings based upon the location that they are in.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
capturing, using at least one sensor associated with an information handling device, environmental data in a user's location;
identifying, from the environmental data, that the user's location is associated with a conference setting, wherein the identifying comprises:
capturing at least one image of the user's location;
ascertaining, based upon analysis of the at least one image, identities for individuals present in the at least one image;
comparing the determined identities to a conference participant list; and
determining, based on the comparing, that the user's location is associated with the conference setting responsive to identifying that one or more of the individuals are listed on the conference participant list; and
determining, from the environmental data, an optimal microphone mode for audible input capture in the user's location; and
adjusting, based on the determining, at least one microphone setting to activate the optimal microphone mode.

2. The method of claim 1, wherein the at least one sensor is selected from the group consisting of an image sensor, a time-of-flight (ToF) sensor, and a microphone sensor.

3. The method of claim 1, wherein the determining comprises identifying that the user's location is associated with a high noise location.

4. The method of claim 3, wherein the identifying that the user's location is associated with the high noise location comprises identifying at least one of: a nature of the user's location, a predetermined number of individuals present in the user's location, and a predetermined ambient noise level in the user's location.

5. The method of claim 3, wherein the optimal microphone mode corresponds to a user only mode when the user's location is associated with the high noise location.

6. The method of claim 1, wherein the determining comprises identifying that the user's location is associated with a conference setting.

7. The method of claim 1, wherein the identifying that the user's location is associated with the conference setting further comprises identifying at least one of: a predetermined number of individuals present in the user's location, a predetermined number of audio streams directed at a portion of the information handling device, and a predetermined number of user gazes directed at the portion of the information handling device.

8. The method of claim 6, wherein the optimal microphone mode corresponds to a multiple voices mode when the user's location is associated with the conference setting.

9. The method of claim 1, wherein the determining comprises identifying that the user's location is associated with a standard location and wherein the optimal microphone mode corresponds to a normal mode when the user's location is associated with the standard location.

10. The method of claim 1, wherein the adjusting the at least one microphone setting comprises adjusting the at least one microphone setting automatically, without any additional user input.

11. An information handling device, comprising:
at least one sensor;
a processor;
a memory device that stores instructions executable by the processor to:
capture environmental data in a user's location;
identify, from the environmental data, that the user's location is associated with a conference setting, wherein the instructions executable by the processor to identify comprise instructions executable by the processor to:
capture at least one image of the user's location;
ascertain, based upon analysis of the at least one image, identities for individuals present in the at least one image;
compare the determined identities to a conference participant list; and
determine, based on the comparing, that the user's location is associated with the conference setting responsive to identifying that one or more of the individuals are listed on the conference participant list; and
determine, from the environmental data, an optimal microphone mode for audible input capture in the user's location; and
adjust, based on the determining, at least one microphone setting to activate the optimal microphone mode.

12. The information handling device of claim 11, wherein the at least one sensor is selected from the group consisting of an image sensor, a time-of-flight (ToF) sensor, and a microphone sensor.

13. The information handling device of claim 11, wherein the instructions executable by the processor to determine comprise instructions executable by the processor to identify that the user's location is associated with a high noise location.

14. The information handling device of claim 13, wherein the instructions executable by the processor to identify that the user's location is associated with the high noise location comprise instructions executable by the processor to identify at least one of: a nature of the user's location, a predetermined number of individuals present in the user's location, and a predetermined ambient noise level in the user's location.

15. The information handling device of claim 13, wherein the optimal microphone mode corresponds to a user only mode when the user's location is associated with the high noise location.

16. (canceled)

17. The information handling device of claim 11, wherein the instructions executable by the processor to identify that the user's location is associated with the conference setting further comprise instructions executable by the processor to identify at least one of: a predetermined number of individuals present in the user's location, a predetermined number of audio streams directed at a portion of the information handling device, and a predetermined number of user gazes directed at the portion of the information handling device.

18. The information handling device of claim 16, wherein the optimal microphone mode corresponds to a multiple voices mode when the user's location is associated with the conference setting.

19. The information handling device of claim 11, wherein the instructions executable by the processor to determine comprise instructions executable by the processor to identify that the user's location is associated with a standard location and wherein the optimal microphone mode corresponds to a normal mode when the user's location is associated with the standard location.

20. A product, comprising:
a storage device that stores code, the code being executable by a processor and comprising:
code that captures environmental data in a user's location;
code that identifies, from the environmental data, that the user's location is associated with a conference setting, wherein the code that identifies comprises:
code that captures at least one image of the user's location;
code that ascertains, based upon analysis of the at least one image, identities for individuals present in the at least one image;
code that compares the determined identities to a conference participant list; and
code that determines, based on the comparing, that the user's location is associated with the conference setting responsive to identifying that one or more of the individuals are listed on the conference participant list; and
code that determines, from the environmental data, an optimal microphone mode for audible input capture in the user's location; and
code that adjusts, based on the determining, at least one microphone setting to activate the optimal microphone mode.
